(19) United States
(12) Patent Application Publication
(10) Pub. No.: US 2026/0195725 A1
(43) Pub. Date: Jul. 9, 2026

(54) ENHANCING SPECTATOR EXPERIENCE THROUGH PARI-MUTUEL WAGERING FOR MULTISTAGE NON-ANIMAL SPORTS EVENTS

(71) Applicants: Gordon C Root, West Linn, OR (US); Jeffrey J. Russell, Fountain Hills, AZ (US)

(72) Inventors: Gordon C Root, West Linn, OR (US); Jeffrey J. Russell, Fountain Hills, AZ (US)

(21) Appl. No.: 19/569,892

(22) Filed: Mar. 17, 2026

Related U.S. Application Data
(63) Continuation-in-part of application No. 19/089,697, filed on Mar. 25, 2025.
Application No. 19/089,697 is a continuation-in-part of application No. 18/898,558, filed on Sep. 26, 2024.
(60) Provisional application No. 63/585,572, filed on Sep. 26, 2023.

(51) Int. Cl. G06Q 20/10; G06Q 50/34

(52) U.S. Cl. CPC G06Q 20/10; G06Q 50/34

(57) ABSTRACT

Systems and methods for wagering on non-animal multi-stage racing events such as motorsports events are provided. The systems and methods include a wagering system configured to acquire event data for the event. The wagering system may distribute the data to wagering placement entities such as on-track sites, off-track wagering sites, casinos, mobile wagering applications, and desktop wagering applications. The wagering system generates odds based on the event data and the wagers. Wagering for a stage of an event may take place up to the beginning of the stage. Wages may be placed on single stages or combinations of stages.

### CROSS REFERENCE TO RELATED APPLICATIONS

This application is a continuation-in-part of U.S. patent application Ser. No. 19/089,697, filed Mar. 25, 2025, which is a continuation-in-part of U.S. patent application Ser. No. 18/898,558, filed Sep. 26, 2024, which claims the priority benefit of U.S. Provisional Appl. No. 63/585,572, filed Sep. 26, 2023, each of which is incorporated herein by reference in its entirety.

### FIELD

The techniques of the disclosure relate broadly to spectator experiences at events, and specific aspects relate to spectator experiences at non-animal related racing competition events. The techniques of the disclosure include methods and systems that facilitate spectators' interaction with events, enhancing spectators' experience during the event.

### BACKGROUND

Sports competition events that feature fields of individual race and contest competitors such as motorsports, sailing, track and field, golf, swimming, skiing, and bicycle racing continue to attract millions of spectators. Spectators typically engage with those events in a passive way by watching them either live or by using broadcast, cable, or streaming services. Spectators may also engage with events by betting on the outcomes, using fixed odds wagering on conventional platforms.

Pari-mutuel wagering has largely been associated with horse racing events. The horse racing industry at one time held the status as the most watched sport in the world. However, on-site attendance has been in decline with the advent of off-track betting, followed by the proliferation of other wagering outlets. For example, there has been rising competition from other forms of gambling such as Native American (tribal) casinos, state lotteries, on-line sports betting, greyhound racing, video gaming, and the like. With this increased competition, the on-track attendance has suffered. With the on-site attendance for horse racing dropping, the tracks have found it increasingly difficult to financially survive. Additionally, horse racing tracks occupy large tracts of real estate for the backside barns, training tracks, the track itself, grandstands, and parking. In many instances the real estate occupied by horse racing tracks has become well-located valuable real estate. As a result, the horse racing tracks close, and the real estate associated with the tracks is sold. The bettors are then displaced and left looking for a viable “like-type” of a gaming experience.

### SUMMARY

The systems, methods, and devices described in this disclosure each have several innovative aspects, no single one of which is solely responsible for the desirable attributes disclosed herein. This summary is provided as a preface to assist those skilled in the art to more rapidly assimilate the detailed design discussion which ensues and is not intended in any way to limit the scope of the claims.

A typical method for pari-mutuel wagering includes receiving, by one or more processors prior to and during a race, race data for the race, the race having a plurality of stages, the race data including one or more results of the plurality of stages. The method further includes receiving, by the one or more processors, funds for a plurality of wagers for the race, each wager of the plurality of wagers associated with the one or more of the plurality of stages. The method further includes generating, by the one or more processors, the wagering odds based upon a fund pool determined by the funds wagered on each race participant in each stage of the race. The method further includes allocating, by the one or more processors, portions of the fund pool based, at least in part, on the one or more results of the plurality of stages and the plurality of wagers.

In some aspects an apparatus for pari-mutuel wagering includes one or more processors. The apparatus further includes a wagering service executable by the one or more processors. The wagering service can be configured to: receive, prior to and during a race, race data for the race, the race data including one or more results for a plurality of stages; receive funds for a plurality of wagers for the race, each wager of the plurality of wagers associated with the one or more of the plurality of stages; generate an odds based fund pool based on the funds wagered; and allocate portions of the fund pool based, at least in part, on the one or more results of the plurality of stages and the plurality of wagers.

In some aspects, a computer readable medium includes instructions for causing one or more processors to receive, prior to and during a race, race data for the race, the race data including one or more results for a plurality of stages. The instructions further include instructions to cause the one or more processors to receive funds for a plurality of wagers for the race, each wager of the plurality of wagers associated with the one or more of the plurality of stages. The instructions further include instructions to cause the one or more processors to generate a fund pool based on the funds wagered. The instructions further include directions to allocate portions of the fund pool to multiple recipients based, at least in part, on the one or more results of the plurality of stages and the plurality of wagers.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. The accompanying drawings in the following description merely show some embodiments of the present disclosure, and a person of ordinary skill in the art can derive other implementations from these accompanying drawings without creative efforts. All the embodiments and implementations will fall within the protected scope of the present disclosure. Having thus described the disclosure in general terms, reference will now be made to the accompanying figures.

FIG. 1 is a flowchart illustrating a system 100 for enhancing spectator experience during an event, in accordance with an example implementation of the techniques of the disclosure.

FIG. 2 is a block diagram 200 illustrating communication between an event and a group of spectators through the system 100, in accordance with an exemplary example implementation of the techniques of the disclosure.

FIG. 3 is a block diagram 300 illustrating a wager offering module 502 configured to offer wagers to the plurality of spectators 206 on interim outcomes, in accordance with an example implementation of the techniques of the disclosure.

FIG. 4 is a block diagram illustrating a method 400 for enhancing the spectator experience during an event, in accordance with an example implementation of the techniques of the disclosure.

FIG. 5 is a flow chart illustrating a system 500 for use in relation to a motorsport race produced by an event producer, in accordance with an example implementation of the techniques of the disclosure.

FIG. 6 is a block diagram 600 illustrating communication between motorsport race 602 and a plurality of spectators 606 through the system 500, in accordance with an exemplary example implementation of the techniques of the disclosure.

FIG. 7 illustrates a diagrammatic representation 700 illustrating a data processing module 702 configured to amalgamate and reformat the race related data (“RRD”), in accordance with an example implementation of the techniques of the disclosure.

FIG. 8 is a block diagram illustrating a method 800 for enhancing the spectator experience during a motorsports race, in accordance with an example implementation of the techniques of the disclosure.

FIG. 9 is a block diagram illustrating a system for conducting pari-mutuel wagering on multi-stage events.

FIG. 10A is a conceptual diagram illustrating an example first wagering period for a multi-stage event.

FIG. 10B is a conceptual diagram illustrating an example second wagering period for the multi-stage event.

FIG. 10C is a conceptual diagram illustrating an example third wagering period for the multi-stage event.

FIG. 10D is a conceptual diagram illustrating an example fourth wagering period for the multi-stage event.

FIG. 11 is a flow chart diagram illustrating example operations for conducting pari-mutuel wagering on multi-stage events.

FIG. 12 is a block diagram of an example computer system upon which embodiments of the inventive subject matter can execute.

It should be noted that the accompanying figures are intended to present illustrations of a few examples of the present disclosure. The figures are not intended to limit the scope of the present disclosure and can be equally utilized for and applied to other non-animal, human race and scored sport events like, for example, a golf event, sailing race events, track and field competition events, bicycle racing events, swimming race events, etc. It should also be noted that the accompanying figures are not necessarily drawn to scale.

### DETAILED DESCRIPTION OF THE INVENTION

In the following detailed description of the invention, numerous specific details are set forth in order to provide a thorough understanding of the invention. However, it will be obvious to a person skilled in the art that the invention may be practiced with or without these specific details. In other instances, well-known methods, procedures, and components have not been described in detail so as not to unnecessarily obscure aspects of the invention.

The accompanying drawings are used to help easily understand various technical features and it should be understood that the alternatives presented herein are not limited by the accompanying drawings. As such, the present disclosure should be construed to extend to any alterations, equivalents, and substitutes in addition to those which are particularly set out in the accompanying drawing. Although the terms first, second, third, etc. may be used herein to describe various elements or values, these elements or values should not be limited by these terms. These terms are generally only used to distinguish one element or value from another.

Other alternative embodiments of the present invention will be apparent to those skilled in the art from consideration of the present disclosure. While the foregoing written description of the invention enables one of ordinary skill to make and use what is considered presently to be the best mode thereof, those of ordinary skill will understand and appreciate the existence of variations, combinations, and equivalents of the specific aspect, method, and examples herein. The invention should therefore not be limited by the above-described alternatives, methods, and examples, but by all aspects and methods within the scope of the invention. It is intended that the specifications and examples be considered as exemplary, with the true scope of the invention being indicated by the claims.

Conditional language used herein, such as, among others, “can,” “may,” “might,” “may,” “e.g.,” unless specifically stated otherwise, or otherwise understood within the context as used, is generally intended to convey that certain alternatives include, while other alternatives do not include, certain features, elements and steps. Thus, such conditional language is not generally intended to imply that certain features, elements, or steps are in any way required for one or more alternatives or that one or more alternatives necessarily include logic for deciding, with or without other input or prompting, whether these features, elements and/or steps are included or are to be performed in any particular alternative. The terms “comprising,” “including,” and “having” are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The techniques of the disclosure provide systems and methods to enhance spectators' experiences for human, non-animal race and scored sports events. One implementation of the techniques of the disclosure is a system and method for implementing pari-mutuel wagering in human, non-animal race events and scored contests where the field of participants is comprised of individual competitors or individual race teams that comprise more than one participant member on a worldwide basis. This system leverages the existing infrastructure already in existence for pari-mutuel betting on horse racing, including dedicated software, betting outlets, web pages, and apps. By adapting and extending this infrastructure to encompass a wide variety of race events and scored contests, the invention creates a new, previously unavailable opportunity for spectators to interact with a variety of race events and scored sports contests through pari-mutuel wagering.

The procedures and techniques described in this disclosure amalgamate event-related data (“ERD”) and then integrate that data into a system and method that allows spectators to make informed wagers. ERD may include personal or team statistics, participant information, historical performance, real-time match or game statistics, and other pertinent data that enrich the spectator's understanding of the event and significantly increase their personal engagement. This data-driven approach provides a valuable connection between human, non-animal race events and scored contests where the field of participants is comprised of individual competitors or race teams that comprise more than one participant member and the spectators' betting experience.

The integration of pari-mutuel wagering into human, non-animal race events and scored contests where the field of participants is comprised of individual competitors or race teams that comprise more than one participant member offers a novel and exciting way for spectators to enjoy the sports events they love. It transforms them from passive observers into active participants, contributing to and sharing in the wagering pool. This not only enhances the excitement of sports events but also fosters a sense of community and engagement among fans.

The techniques described in this disclosure bridge the world of human, non-animal race events and scored contests where the field of participants is comprised of individual competitors or race teams that comprise more than one participant member with the established framework of pari-mutuel betting, providing fans with an innovative and interactive way to connect with their favorite sports and star competitors. By capitalizing on existing infrastructure and offering a platform for new pari-mutuel wagering opportunities on a variety of sports events, the system and method enhances spectators' experiences by creating a more immersive and engaging event environment for spectators worldwide.

In some aspects, the techniques of the disclosure offer ways to enhance spectators' experiences.

In some aspects, the techniques of the disclosure establish a novel approach for sports betting, introducing the concept of pari-mutuel wagering to motorsports and other non-animal-related sports events. Such aspects enhance the enjoyment and engagement of sports enthusiasts by enabling them to actively participate in wagering on their favorite teams, athletes, or sporting events.

In some aspects, the techniques of the disclosure extend the functionality of pari-mutuel wagering on various sports events, creating a seamless transition for both betting operators and spectators.

In some aspects, the techniques of the disclosure provide spectators with event-related data that informs their wagering decisions. This data may include real-time statistics, historical performance, player or team profiles, and other relevant information, enriching the betting experience. Such aspects enable informed wagering and enhance the connection between the spectator and the sports event.

In some aspects, the techniques of the disclosure transform spectators from passive observers into active participants, offering them an engaging and interactive role in the sports event. Such aspects create a more immersive and dynamic spectator experience by allowing spectators to wager on various aspects of the event, thus increasing their emotional investment and enjoyment.

In some aspects the techniques of the disclosure provide a universally accessible platform for sports betting and engagement.

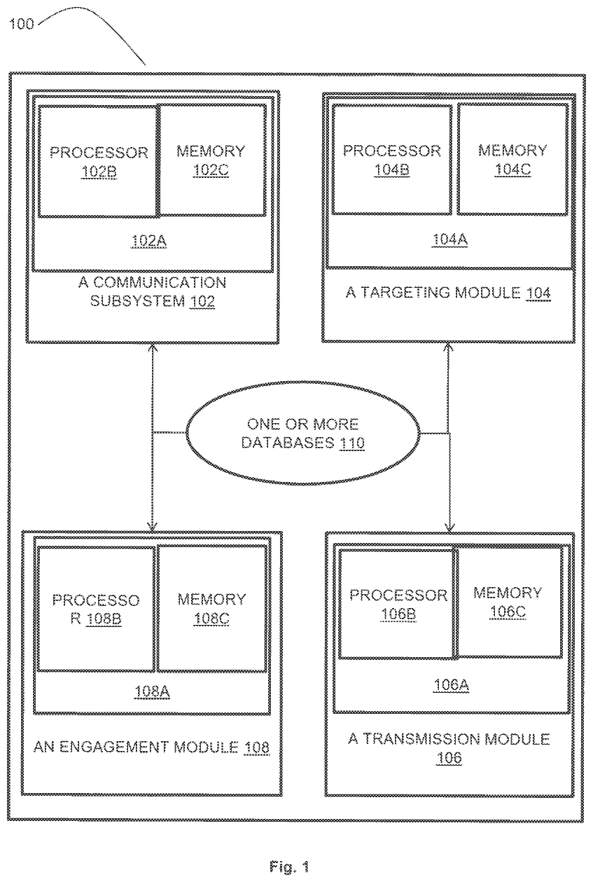

FIG. 1 is a flowchart illustrating a system 100 for enhancing spectator experience during an event, in accordance with an example implementation of the techniques of the disclosure. The system 100 may be produced by an event producer for use in relation to the event. In some implementations, the event may be any of but not limited to non-animal-related sports events such as a motorsports race, a sailing race, track and field events, a golf tournament, etc. In addition, the event may occur between the beginning time up to the end time and may produce one or more categories of interim outcomes between the beginning time up to the end time.

In some implementations, the system 100 may be configured to identify the one or more categories of interim outcomes to a target group of spectators. In addition, the system 100 may be configured to report to the target group of spectators in a period between the beginning time and the end time the interim outcomes as they become known during the event. Further, the system 100 may measure a level of spectator engagement with the event.

In a specific example implementation of the techniques of the disclosure, the system 100 may include a communication subsystem 102, a targeting module 104, a transmission module 106 and an engagement module 108. Other implementations of the techniques of the disclosure may or may not include other modules to implement the techniques.

In some implementations, the communication subsystem 102 may be configured to acquire ERD for the event. The ERD may include one or more categories of interim outcomes before the beginning time of the event and the interim outcomes as they become known during the event.

In some implementations, the communication subsystem 102 may include a control subsystem 102a. The control subsystem 102a may include a processor 102b, at least one database 110, and a computer readable memory unit 102c that produces processor readable instructions that are executed by the processor 102b and cause the processor 102b to acquire the ERD for the event. The computer readable memory 102c in the control subsystem 102a may be used to store the ERD.

The processor 102b associated with the control subsystem 102a may be any well-known processor, including, but not limited to, processors from Intel Corporation or Tiawan Semiconductor Manufacturing Company. Alternatively, the processor may be a dedicated controller such as an ASIC or ARM, MIPS, SPARC, or INTEL® IA-32 microcontroller.

Similarly, in yet another example implementation of the techniques of the disclosure, the processor 102b may comprise a collection of processors which may or may not operate in parallel. The processor 102b may be any processor-driven device, such as may include one or more microprocessors and memories or other computer-readable media operable for storing and executing computer-executable instructions. Examples of processor driven devices may include, but are not limited to, a server computer, a mainframe computer, one or more networked computers, a desktop computer, a personal computer, an application-specific circuit, a microcontroller, a minicomputer, or any other processor based device.

Also, the processor 102b may execute any set of instructions directly as computer executable codes or indirectly (such as scripts). In that regard, the terms “instructions,” and “steps” may be used interchangeably herein. The instructions may be stored in object code form for direct processing by the processor 102b, or in any other computer language including scripts or collections of independent source code modules that are interpreted on demand or compiled in advance.

In accordance with an example implementation of the techniques of the disclosure, the computer readable memory 102c is configured with the processor 102b for storing the ERD. For example, the computer readable memory 102c may store software used by a user interface or the processor, such as an operating system (not shown), application programs (not shown), and an associated internal database (not shown).

In addition, the computer readable memory 102c associated with the control subsystem 102a stores instructions to be executed by the control subsystem 102a. The computer readable memory 120c can be any type of suitable memory, including various types of dynamic random-access memory (DRAM) such as SDRAM, various types of static RAM (SRAM), and various types of non-volatile memory (PROM, EPROM, and flash). It should be understood that the computer readable memory 102c may be a single type of memory component or it may be composed of many different types of memory components. As noted above, the computer readable memory 102c stores instructions for executing one or more methods for enhancing spectator experience during an event. For example, the computer readable memory may store software used by the user device, such as an operating system (not shown), application programs (not shown), and an associated internal database (not shown). In an alternative embodiment, the computer readable memory 102c may be an external memory to the control subsystem 102a to store various data and computer executable instructions.

In some embodiments, the computer readable memory 102c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules, and other data for the processor. Those skilled in the relevant art will appreciate that other types of storage devices may be employed to store digital data accessible by a computer, such as magnetic cassettes, flash memory cards, RAMs, ROMs, smart cards, or cloud or space-based solutions, etc.

As an example, and not by way of limitation, the computer readable memory 102c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, cloud or space-based systems, and electrostatic storage devices such as solid-state drives.

In some implementations, the communication subsystem 102 may include one or more sensors (not shown in figures) for real-time data acquisition of the event. In an example, one or more sensors may be installed at one or more locations where the event is held to monitor weather and atmospheric conditions such as temperature, humidity, wind speed, air quality indexes, and temperature-humidity air index, that may affect the outcome of the event. In accordance with an example implementation of the techniques of the disclosure, the data from the one or more sensors is transmitted to the target group of spectators.

In some implementations, the communication subsystem 102 may be configured to acquire transmission signals of live events, chosen from the group consisting of broadcast and streaming signals. In an exemplary embodiment, the communication subsystem 102 may be wired or wireless. The wired communication may include any of but not limited to landline phones which use copper wires that transmit voice signals and fiber-optic communication that transmits data using light signals through optical fibers. The wireless communication may include but not limited to Wi-Fi, which may allow devices to connect through the internet and communicate wirelessly, and Bluetooth, which may be used for short-range connections between devices like headphones, tablets, and smart phones. In addition, the communication subsystem 102 may be any of but not limited to a plurality of smart phones which use land-based and earth-orbiting satellite cellular networks to transmit voice, text messages, and data and a plurality of land-based cell towers and earth-orbiting satellites which use relay signals from the phones to the network.

In another example, the communication subsystem 102 may be a telemetry system which allows for real-time analysis and decision-making during the event in which events equipment are equipped with the telemetry system that continuously transmit ERD, including performance of a race vehicle in case of a motorsport racing event, vehicle speed, tire condition, fuel levels of a vehicle, and driver biometrics, back to the spectator which allows for real-time analysis and decision-making during a motorsport race event.

In yet another example, the communication subsystem 102 may include cameras mounted on, for example, race cars or sailing vessels to capture video footage in case of a racing event, which is streamed to the event control center and broadcasted to the fans. In yet another example, the communication system 102 may integrate with timing and scoring equipment to provide precise information about lap times, sector times and event positions to teams, race control and spectators in case of a racing event. In yet another example, the communication system 102 may include any of trackside sensors, GPS tracking, race data analysis tools, driver biometrics, and team communication networks which, in the case of a motorsport racing event, can be distributed to spectators, which can enhance their experiences during the racing event. The above-mentioned examples may illustrate that a communication system may be configured to acquire, process, and distribute ERD to various spectators, enhancing the event experience and ensuring the safety and efficiency of the event.

In some implementations, the targeting module 104 may be configured to select a target group of spectators based on a predetermined criterion. In some implementations, the predetermined criteria for selecting the target group of spectators may include at least one of geographical location, user preferences, and user demographics. In another example implementation of the techniques of the disclosure, the predetermined criterion may or may not include other parameters performing similar function.

In some implementations, the targeting module 104 may include a control subsystem 104a. The control subsystem may include a processor 104b, at least one database 110 and a computer readable memory 104c including a processor-readable instruction that may be executed by the processor 104b and may cause the processor 104b to select the target group of spectators based on the predetermined criterion. The computer readable memory 104c in the control subsystem 104a may be used to store the target group of spectators.

In some implementations, the processor 104b, the computer readable memory 104c and the one or more database 110 of the targeting module 104 may be any of the above-mentioned processors, memory units, and databases used for the communication subsystem 102.

In an example, the targeting module 104 may select the target group of spectators by using a ticket type targeting in which different ticket categories can be used as a criterion to tailor messages, offers, and experiences to specific ticket holders. In another example, the targeting module 104 may select the target group of spectators using location-based targeting in which spectators situated in different locations can receive targeted information.

In yet another example, the targeting module 104 may select the target group of spectators by determining their interests, such as favorite teams or drivers in case of a racing event, and deliver updates, statistics, and special content related to those preferences. In yet another example, the targeting module 104 may select the target group of spectators based on engagement level in which spectators who actively engage with the event app or show a high level of interest by checking into different event locations can receive rewards or recognition for their participation.

In some implementations, the targeting module 104 may select the target group of spectators based on user demography in which criteria such as age, gender, or language preference can be used to customize content and promotions. For instance, families with children might receive information about family-oriented on-site activities at the event.

In some implementations, the transmission module 106 is configured to transmit the acquired ERD to the target group of spectators. In some implementations, the transmission module 106 may include a control subsystem 106a. The control subsystem may include a processor 106b, at least one database 110, and a computer readable memory 106c that may include a processor-readable instruction that is executed by the processor 106b and may cause the processor 106b to transmit the acquired ERD to the target group of spectators.

In some implementations, the processor 106b, the computer readable memory 106c, and the one or more databases 110 of the transmission module 106 may be any of the above-mentioned processors, memory units, and databases.

In an example, the transmission module 106 may transmit the acquired ERD to the target group of spectators before the start of the race event and during the event by delivering real-time commentary, event updates, and announcements to spectators, providing insights into the race event, statistics, and event-related news.

In another example, the transmission module 106 may transmit the acquired ERD to the target group of spectators by using live audio where spectators can access live radio broadcasts or audio commentary on their smartphones, tablets, or portable radios, allowing them to choose their preferred audio feed, including team radio communications.

In yet another example, the transmission module 106 may transmit the acquired ERD to the target group of spectators by providing live event coverage and camera feeds on their smartphones, tablets, or other mobile devices. Different camera angles and race-specific feeds can be offered for a more personalized experience.

In yet another example, the transmission module 106 may transmit the acquired ERD by using real-time leader boards and statistics, fan engagements apps, social media feeds, and fan zone information.

In some implementations, the engagement module 108 may allow the target group of spectators to interact with the event by using the ERD, causing the spectators to have an enhanced spectator experience. In some implementations, the enhanced spectator experience caused by the engagement module 108 may be chosen from the group consisting of participants in the event, having an emotional experience during the event, enjoying the event more than they would have without the system, betting on the outcome of the event, or a combination of each of those things. In addition, the engagement module 108 may measure the level of spectator engagement in the event.

In some implementations, the engagement module 108 may allow for the target group of spectators to place wagers between the beginning time and the end time on one or more of the interim outcomes. In addition, the engagement module 108 may measure the level of spectator engagement based at least in part from the wagers placed by the target group of spectators.

The engagement module 108 may measure the level of spectator engagement based on at least one factor chosen from the group consisting of participating in the event, having an emotional experience during the event, enjoying the event more than they would have without the system, betting on the outcome of the event, or a combination of each of those things. Further, the engagement module 108 may enable the target group of spectators to place bets on various event outcomes chosen from the group consisting of final times, final scores, final point tallies, race statistics, participant statistics, specific race events, and specific game events.

In some implementations, the system 100 may further include a data processing module configured to analyze the ERD and provide real-time odds for betting on the event outcome based on the analyzed data. In some implementations, the system 100 may establish a two-way communication between the event and the spectator. The two-way communication allows spectators to have enhanced engagement with the event.

In some implementations, the engagement module 108 includes a control subsystem 108a. The control subsystem 108a may include a processor 108b, at least one database 110 and a computer readable memory 108c that includes a processor readable instruction that is executed by the processor 108b and may cause the processor 108b to interact with the event by using the ERD, causing spectators to have an enhanced spectator experience.

In some implementations, the processor 108b, the computer readable memory 108c, and the one or more database 110 of the engagement module 108 may be any of the above-mentioned processors, memory and databases used for the communication subsystem 102.

In some implementations, the engagement module 108 may enable the target group of spectators to place bets on various event outcomes chosen from the group consisting of final times or results, final scores, final point tallies, race statistics, participant statistics, specific race events, and specific game events.

In an example, a dedicated mobile app may allow spectators to place wagers on various race outcomes, such as, for example, the final order of race finishers, final order of podium finishers, fastest lap times, or a combination of the finish positions such as quinella, exacta and trifecta wagering. In another example, the engagement module 108 may allow interaction of the target group of spectators by providing a live betting platform where spectators can use a real-time betting platform to make dynamic wagers during the event, adjusting their bets as the event unfolds.

In some implementations, the system 100 may include a wager offering module configured to offer wagers to the target group of spectators on interim outcomes between the start and finish of the race.

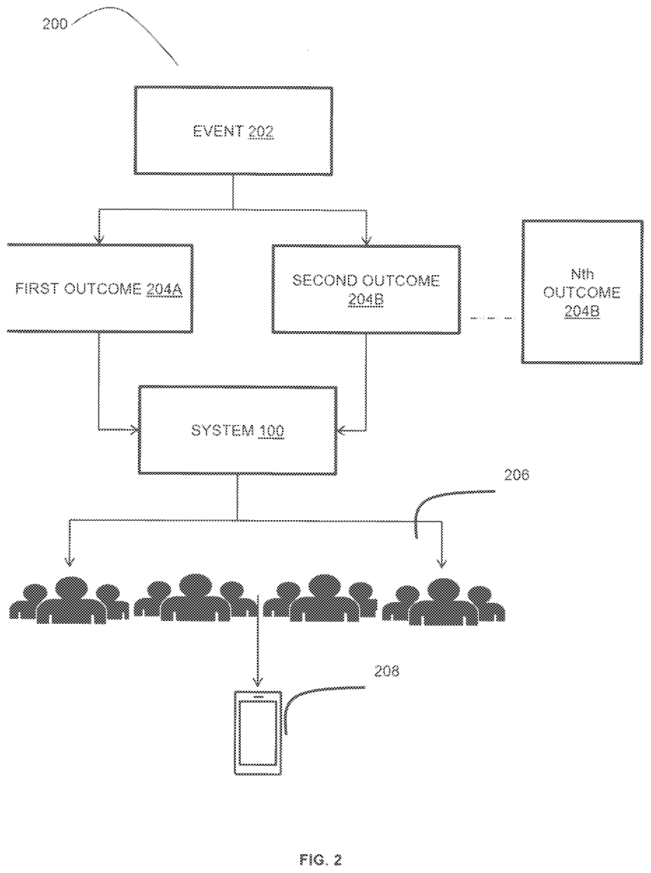

FIG. 2 is a block diagram 200 illustrating the communication between an event 202 and a group of spectators 206 through the system 100, in accordance with an exemplary example implementation of the techniques of the disclosure. The event may include “n” outcomes, where n is a natural number. In an example, the event may include a first outcome 204a and a second outcome 204b.

In some implementations, the system 100 may provide wagers to the plurality of spectators 206 to engage with the event 202. The plurality of spectators participates in the event 202 by applying on the outcomes of the event, where the outcome may be the first outcome 204a, the second outcome 204b up to the nth outcome of the event 202.

In some implementations, the plurality of spectators 206 may receive ongoing statistics related to the outcomes of the event 202 on their mobile devices 208. The mobile devices 208 may allow the plurality of spectators 206 to communicate with the event 202 through the mobile device 208. The communication between the plurality of spectators 206 and the event 202 may be a two-way communication which enhances the event engagement.

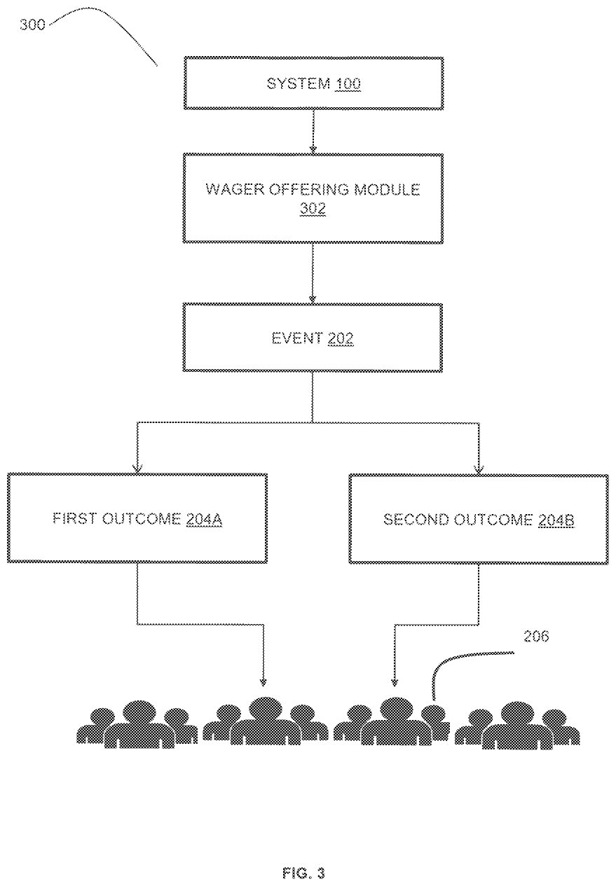

FIG. 3 is a block diagram 300 illustrating a wager offering module 502 configured to offer wagers to the plurality of spectators 206 on interim outcomes between the beginning time and the end time, in accordance with an example implementation of the techniques of the disclosure (References have been made to FIG. 1 and FIG. 2).

In some implementations, the wager offering module 502 may be associated with the system 100. In an example, the event 202 has one or more outcomes which may include any of, but may not be limited to, the first outcome 204a and the second outcome 204b. In addition, the wager offering module 502 may enhance engagement of the plurality of spectators 206 with the event 202 by offering wagers on the one or more outcomes of the event 202.

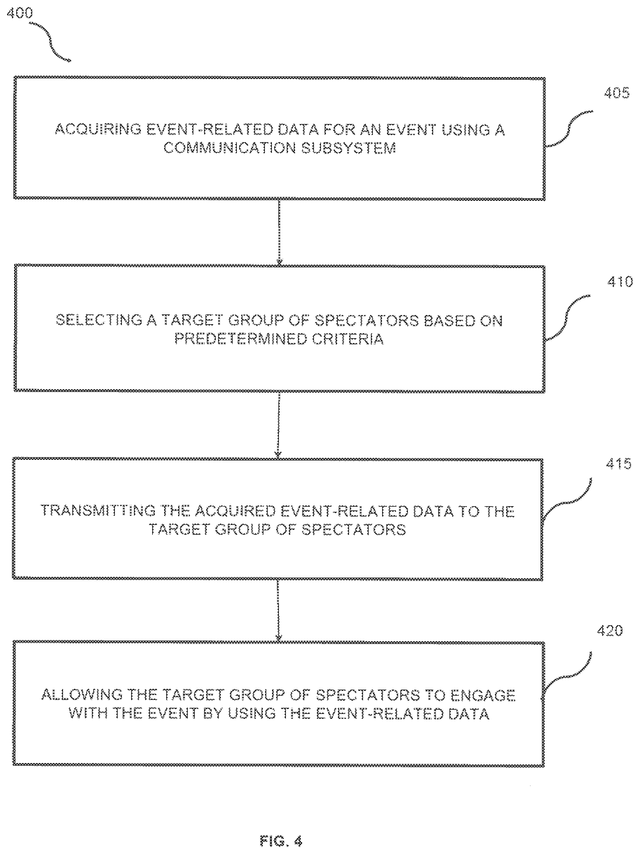

FIG. 4 is a block diagram illustrating a method 400 for enhancing spectators' experiences during an event, in accordance with an example implementation of the techniques of the disclosure. In one specific embodiment, the flow chart 400 may include steps to illustrate the method for enhancing the spectator experience during the event. Other embodiments may include other steps to illustrate similar methods.

In some implementations, the method may initiate at step 405 and terminate at step 420. At step 405, the method 400 may include acquiring ERD for the event using a communication subsystem 102. (References have been made to FIG. 1)

At step 410, a target group of spectators may be selected based on a predetermined criterion. In some implementations, the predetermined criteria for selecting the target group of spectators may include one or more of the following: geographical location, user preferences, user demographics, and user wagering history. In another example implementation of the techniques of the disclosure, the predetermined criteria may or may not include other parameters performing similar function.

At step 415, the acquired ERD may be transmitted to the target group of spectators. At step 220, the target group of spectators may be allowed to engage with the event by using the ERD, causing the spectators to realize a personalized, unique, and significantly enhanced spectator experience. In some implementations, the enhanced spectator experience caused by the allowing step 420 may be chosen from the group consisting of participants in the event. The participants may have an emotional experience during the event, enjoying the event more than they would have without the system 100, betting on the outcome of the event, or a combination of each of those things.

In some implementations, the step 420 of allowing the target group of spectators to engage with the sporting event may include placing wagers on various event outcomes chosen from the group consisting of the order of finish in the race or a combination of the order of finish such as win, place, show, quinella, exacta, or trifecta. In another example implementation of the techniques of the disclosure, the group of various event outcomes may include any other parameters relating to a specific sporting event.

In some implementations, the method 400 further includes real-time analysis of the ERD to provide updated odds for betting to the target group of spectators. In some implementations, the totality of the ERD may be amalgamated into a standardized data format to facilitate and enable transmission through a plurality of third parties involved in the event.

In an example of the implementation of the techniques described in this disclosure, a computer-readable medium may include computer-executable instructions for implementing the method for enhancing spectator experience during an event. In the example, the computer-readable medium may be any of, but not limited to, the following devices that are capable of storing both data and executable software instructions: a memory card; a CD-ROM or DVD that can be read by a computer's optical drive; a USB Flash Drive; a Hard Disk Drive; a Solid State Drive; a Magnetic Tape; Cloud Storage in which data files and instructions are stored in a data cloud system such as Google Drive or Dropbox; network storage; remote repositories; ROM; EPROM; or EEPROM.

FIG. 5 is a flow chart illustrating a system 500 for use in relation to a motorsport race produced by an event producer, in accordance with an example implementation of the techniques of the disclosure. The system 500 may be configured for collecting wagers from a betting populace, for allocating a portion of the wagers as revenue to the event sponsors and producers, and for enhancing the experience of a plurality of spectators during a motorsport race or other sporting event. In a specific embodiment, the system 500 may include a communication subsystem 502, a targeting module 504, a transmission module 506, an engagement module 508, an allocation module 512, and one or more databases 510. Other implementations of the techniques described in this disclosure may or may not include other modules to implement the techniques.

In some implementations, the communication subsystem 502 may be configured to acquire current, ongoing race-related data (“RRD”) for an in-progress motorsport race event. In some implementations, the communication subsystem 502 may include a control subsystem 502a. The control subsystem 502a may include a processor 502b, at least one database 510 and a computer readable memory 502c which may include a processor readable instruction that is executed by the processor 502b and may cause the processor 502b to acquire the RRD for the motorsport race. The computer readable memory 502c in the control subsystem 502a may be used to store the RRD.

The processor 502b may be associated with the control subsystem 502a may be any well-known processor, including, but not be limited to, processors from Intel Corporation. Alternatively, the processor 502b may be a dedicated controller such as an ASIC, ARM, MIPS, SPARC, or INTEL® IA-32 microcontroller.

Similarly, in yet another example implementation of the techniques of the disclosure, the processor 502b may comprise a collection of processors which may or may not operate in parallel. The processor 502b may be any processor-driven device, such as may include one or more microprocessors and memories or other computer readable media operable for storing and executing computer executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 502b may execute any set of instructions directly as computer executable codes or indirectly (such as scripts). In that regard, the terms “instructions,” and “steps” may be used interchangeably herein. The instructions may be stored in object code form for direct processing by the processor 502b, or in any other computer language including scripts or collections of independent source code modules that are interpreted on demand or compiled in advance.

In accordance with an example implementation of the techniques of the disclosure, the computer readable memory 502c may be configured with the processor 502b for storing the ERD. For example, the computer readable memory 502c may store software used by a user interface or the processor 502b, such as an operating system (not shown), application programs (not shown), and an associated internal database (not shown).

In addition, the computer readable memory 502c may be associated with the control subsystem 502a stores instructions to be executed by the control subsystem 502a. The computer readable memory 502c may be any type of suitable memory, including various types of dynamic random-access memory (DRAM) such as SDRAM, various types of static RAM (SRAM), and various types of non-volatile memory (PROM, EPROM, and flash). The computer readable memory 502c may be a single type of memory component, or it may be composed of many different types of memory components. As noted above, the computer readable memory 502c stores instructions for executing one or more methods for enhancing spectator experience during the race. For example, the computer readable memory 502c may store software used by the user device, such as an operating system (not shown), application programs (not shown), and an associated internal database (not shown). In an alternative embodiment, the computer readable memory 502c may be an external memory to the control subsystem 502a to store various data and computer executable instructions.

In some embodiments, the computer readable memory 502c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 502c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, and electrostatic storage devices such as solid-state drives.

In some implementations, the communication subsystem 502 may include one or more sensors (not shown in figures) for real-time data acquisition of the sailing or motorsport race. In an example, the one or more sensors may be placed around the racetrack to monitor environmental conditions such as temperature, humidity, wind speed and direction, and track conditions such as grip levels, choppiness, debris, and safety status. In accordance with an example implementation of the techniques of the disclosure, the data from the one or more sensors may be transmitted to the plurality of spectators.

In some implementations, the communication subsystem 502 may be configured to acquire transmission signals of live races, chosen from the group consisting of broadcast and streaming signals. In an example, the communication subsystem 502 may be wired or wireless. The wired communication includes, but is not limited to, landline phones that use copper wires to transmit voice signals and fiber-optic communication lines that transmit data using light signals through optical fibers. The wireless communications may include, but not be limited to, Wi-Fi, which allows devices to connect through the internet and communicate wirelessly, and Bluetooth, which is used for short-range connections between devices like headphones, tablets, and smart phones. In addition, the communication subsystem 502 may be any of but not limited to a plurality of smart phones which use land-based cellular networks or orbital satellite systems to transmit voice, text messages, and data to a plurality of cell towers or satellites which use relay signals from the smart phones and tablets to the network.

In another example, the communication subsystem 502 may be a telemetry system which allows for real-time analysis and decision-making during the race in which race cars or boats are equipped with the telemetry system that continuously transmit RRD, which may include, but not be limited to, data that indicates current engine performance, speed, tire condition, fuel levels, and driver biometrics, to the race team's pit area which allows for real-time analysis and decision-making during the race event.

In yet another example, the communication subsystem 502 may include cameras mounted on race cars or boats to capture video footage, which is streamed to the race control center and broadcasted to the fans. In yet another example, the communication system 502 may integrate with timing and scoring equipment to provide precise information about lap times, sector times and race positions to teams, race control, and spectators. In yet another example, the communication system 502 may include any of trackside sensors, GPS tracking, race data analysis tools, driver biometrics, team communication networks, and other data that is distributed to spectators. The above-mentioned examples illustrate that a communication system can be configured to acquire, process, and distribute RRD to multiple spectators, regardless of their location, which will greatly enhance the spectators' experience of the race events.

In some implementations, the targeting module 504 may be configured to select a target group of spectators from the plurality of spectators based on a predetermined criterion. In some implementations, the targeting module 504 may include a control subsystem 504a. The control subsystem includes a processor 504b, the least one database 510 and a computer readable memory 504c which includes a processor-readable instruction that is executed by the processor 504b and causes the processor 504c to select the target group of spectators based on the predetermined criterion. The computer readable memory 504c in the control subsystem is used to store the target group of spectators.

In some implementations, the processor 504b, the computer readable memory 504c and the one or more database 510 of the targeting module 504 may be any of the above-mentioned processors, memory, and databases used for explaining the communication subsystem 502.

In some implementations, the predetermined criteria for selecting the target group of spectators may include one or more of the following attributes: geographical location; user preferences; user demographics; and user wagering history. In another example implementation of the techniques of the disclosure, the predetermined criterion may or may not include other parameters performing similar function.

In an example, the targeting module 504 may select the target group of spectators by using a ticket type targeting in which different ticket categories can be used as a criterion to tailor messages, offers, and experiences to specific ticket holders. In another example, the targeting module 504 may select the target group of spectators using location-based targeting in which spectators situated in different locations can receive targeted information.

In yet another example, the targeting module 504 may select the target group of spectators by determining their interests, such as favorite racing teams or drivers, and deliver updates, statistics, and special content related to those preferences. In yet another example, the targeting module 504 may select the target group of spectators based on engagement level in which spectators who actively engage with the race event app or show a high level of interest by checking into different race locations can receive rewards or recognition for their participation.

In some implementations, the targeting module 504 may select the target group of spectators based on user demography in which criteria such as age, gender, or language preference can be used to customize content and promotions. For instance, families with children might receive information about family-oriented activities at the race event.

In some implementations, the transmission module 506 may be configured to transmit the acquired ERD to the target group of spectators. In some implementations, the transmission module 506 includes a control subsystem 506a. The control subsystem may include a processor 506b, at least one database and 510 a computer readable memory 506c including a processor-readable instruction that is executed by the processor 506b and causes the processor 506b to transmit the acquired ERD to the target group of spectators.

In some implementations, the processor 506b, the computer readable memory 506c and the one or more database of the transmission module 506 may be any of the above-mentioned processors, memory units, and databases used for the transmission module 506.

In an example, the transmission module 506 transmits the acquired ERD to the target group of spectators by delivering real-time commentary, race updates, and announcements to spectators in attendance at the race event or that may be watching the race event at an off-site location, providing insights into the race, driver statistics, and event-related news.

In another example, the transmission module 506 may transmit the acquired ERD to the target group of spectators by using live audio where spectators can access live radio broadcasts or audio commentary on their smart phones, tablets, or portable radios, allowing them to choose their preferred audio feed, including team radio communications.

In yet another example, the transmission module 506 may transmit the acquired ERD to the target group of spectators by providing live race coverage and camera feeds on their smart phones or mobile devices. Different camera angles and driver-specific feed can be offered to provide spectators an enhanced and more personalized experience.

In yet another example, the transmission module 506 may transmit the acquired ERD by using real-time leader boards and statistics, fan engagements apps, social media feeds, and fan zone information.

In some implementations, the engagement module 508 may allow the target group of spectators to interact with the race by using the RRD to place pari-mutuel wagers about motorsport race outcomes. In some implementations, the engagement module 508 may include a control subsystem 508a. The control subsystem 508a includes a processor 508b, the least one database 510 and a computer readable memory 508c including a processor-readable instruction that is executed by the processor 508b and cause the processor 508c to interact with the motorsport race event by using the RRD, causing spectators to have an enhanced and more personalized experience.

In some implementations, the processor 508b, the computer readable memory 508c and the one or more database 510 of the engagement module 508 may be any of the above-mentioned processor, memory and database used for explaining the communication subsystem 502.

In some implementations, the enhanced spectator experience may result when the engagement module 508 is chosen from the group consisting of participants in the motorsport race event, having an emotional experience during the race, enjoying the race more than they would have without the system 500, betting on the outcome of the race, or a combination of each of those things.

In some implementations, the engagement module 508 may allow the target group of spectators to interact with the sailing or motorsport race by placing parimutuel wagers on race outcomes which adds excitement and engagement to the race. In an example, a dedicated mobile app may allow spectators to place wagers on various race outcomes, such as the final order of race finishers, final order of podium finishers, or a combination of the finish positions such as quinella, exacta and trifecta wagering.

In another example, the engagement module 508 may allow interactions by the target group of spectators by providing a live betting platform where spectators can use a real-time betting platform to make dynamic wagers during the race by adjusting their bets as the race unfolds.

In some implementations, the system 500 may establish a two-way communication between the motorsport race and the spectator. The two-way communication allows the spectator to have enhanced engagement with the motorsport race.

In some implementations, the system 500 further includes a data processing module configured to amalgamate and reformat the RRD into a standardized data feed that is receivable by parimutuel platforms that provide real-time odds for betting based upon the analyzed data.

In some implementations, the allocation module 512 may be configured to designate and transmit to the event producer, race drivers or participant, and race teams a portion of the parimutuel wagering pools. The allocation module 512 may include a control unit 512a, a processor 512b, a memory 512c and the one or more databases 512.

In some implementations, the processor 508b, the computer readable memory 508c and the one or more database 510 of the engagement module 508 may be any of the above-mentioned processors, memory units, and databases used for explaining the communication subsystem 502.

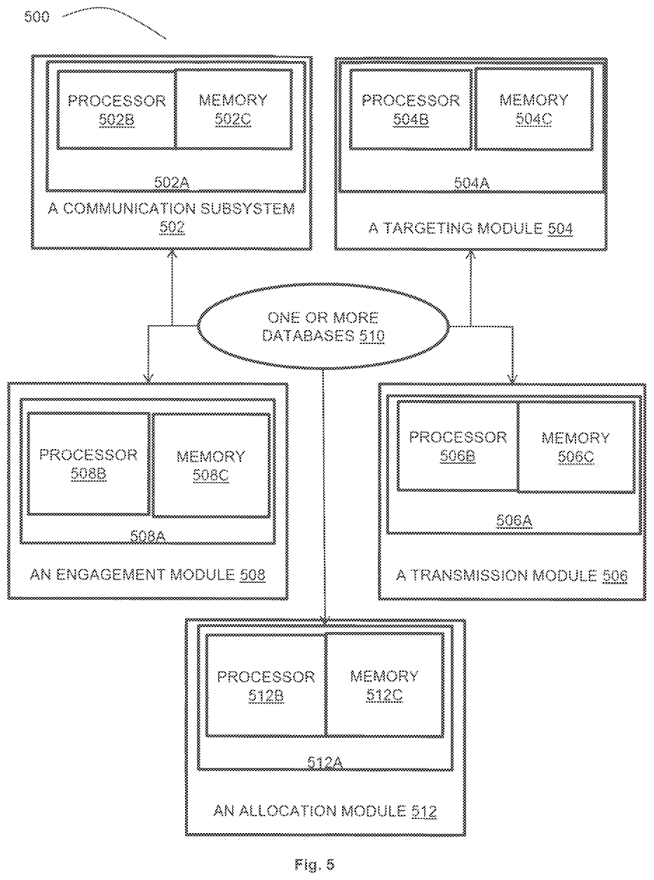

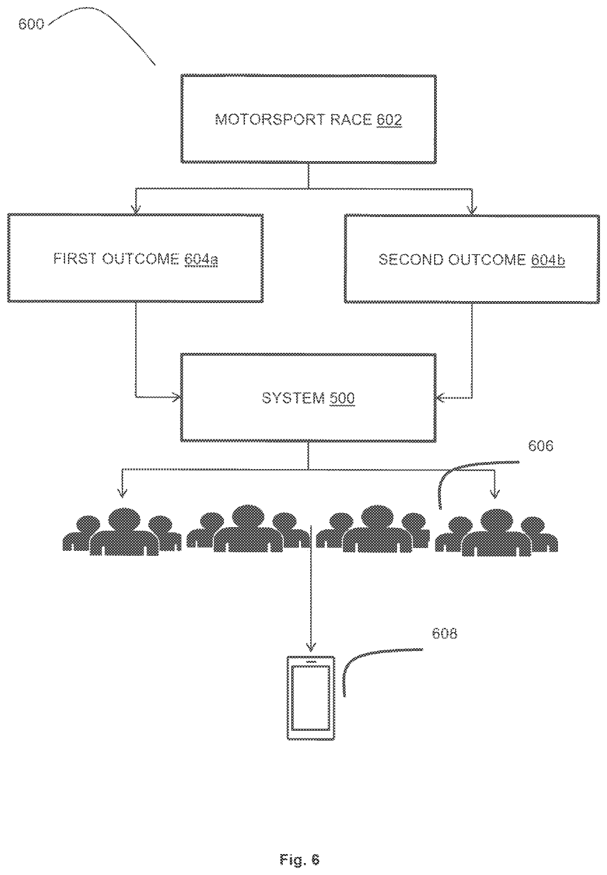

FIG. 6 is a block diagram 600 illustrating the communication between a sailing or motorsport race 602 and a plurality of spectators 606 through the system 500, in accordance with an exemplary example implementation of the techniques of the disclosure. The event may include “n” outcomes, where n is a natural number. In an example, the event may include a first outcome 604a and a second outcome 604b.

In some implementations, the system 500 may provide wagers to the plurality of spectators 606 to engage with the sailing or motorsport race 602. The plurality of spectators 606 participates in the sailing or motorsport race 602 by applying on the outcomes of the sailing or motorsport race, where the outcome may be the first outcome 604a, the second outcome 204b up to the nth outcome of the race 602.

In some implementations, the plurality of spectators 606 may receive ongoing statistics related to the outcomes of the sailing or motorsport race 602 on their smart phone, tablet, or other mobile devices 608. The smart phone, tablet, or other mobile devices 608 may allow the plurality of spectators 606 to communicate with the sailing or motorsport race 602 through the mobile device 608. The communication between the plurality of spectators 606 and the event 602 may be a two-way communication which enhances the race engagement.

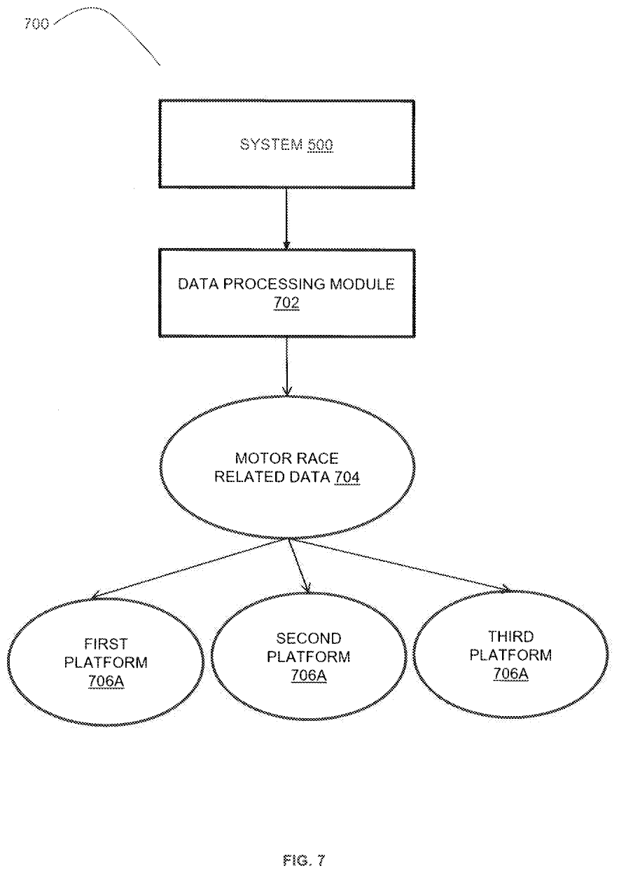

FIG. 7 illustrates a diagrammatic representation 700 illustrating a data processing module 702 configured to amalgamate or combine and reformat the RRD, in accordance with an example implementation of the techniques of the disclosure. The RRD is amalgamated, combined and reformatted into a standardized data feed that is receivable by a plurality of pari-mutuel platforms that provide real-time odds for betting based upon the analyzed data, in a representative example implementation of the techniques of the disclosure.

In some implementations, the plurality of parimutuel platforms that may receive the standardized data feed associated with the RRD include a first platform 706a, a second platform 706b, a third platform 706c, and so on.

In some implementations, the first platform 706a may be a dedicated parimutuel platform designed to receive and process the standardized data feed for race-related data. In addition, the second platform 706b is any parimutuel platform configured to accept and utilize the standardized data feed for providing real-time odds for betting on races. Further, the third platform 706c is another parimutuel platform in the described embodiment, intended to receive and process the standardized data feed for race-related information. There may be more platforms beyond the specifically mentioned ones. The platforms collectively form part of the system designed to process and present real-time odds for betting based on the analyzed race data and the amounts wagered on each participant or team,

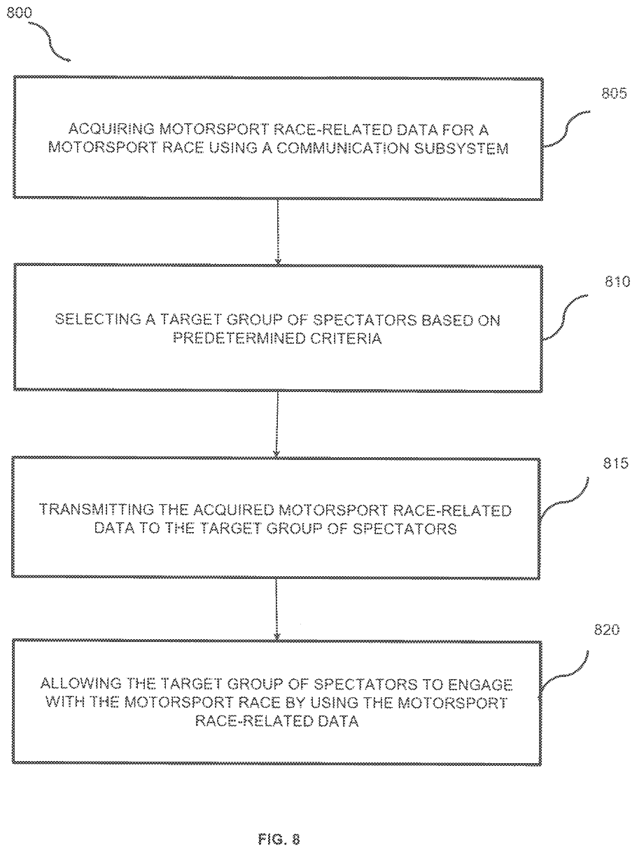

FIG. 8 is a block diagram illustrating a method 800 for enhancing the spectator experience during race events, in accordance with an example implementation of the techniques of the disclosure. In one specific embodiment, the flow chart 800 may include steps to illustrate the method for enhancing the spectator experience during the race event. Other embodiments may include other steps to illustrate similar methods.

In some implementations, the method initiates step 805 and terminates at step 820. At step 805, the method 800 may include acquiring RRD for a race event using a communication subsystem 502 (References have been made to FIG. 5).

In addition, the step 805 may also include acquiring transmission signals of live races, chosen from the group consisting of broadcast and streaming signals. Further, the step 805 includes using the communication subsystem 502 with at least one sensor for real-time acquisition of RRD.

At step 810, a target group of spectators may be selected based on a predetermined criterion. In some implementations, the predetermined criteria for selecting the target group of spectators includes one or more of the following: geographical location; user preferences; user demographics; and user wagering history. In another example implementation of the techniques described in this disclosure, the predetermined criteria may or may not include other parameters performing similar function.

At step 815, the acquired RRD may be transmitted to the target group of spectators. At step 820, the target group of spectators are allowed to engage with the race event by using the RRD to make decisions regarding placement of pari-mutuel wagers on race outcomes, causing the spectators to have a more personal and significantly enhanced spectator experience.

Spectators may have an emotional experience during the race event, enjoying the event more than they would have without the system 400, having the opportunity to place a multiple variety of pari-mutuel wagers on a multiple variety of outcomes of the race event, or a combination of each of those things.

In some implementations, the step 820 of allowing the target group of spectators to engage with the race event includes placing pari-mutuel wagers on multiple varieties of race outcomes chosen from a combination of the finish positions such as win, place, show, quinella, exacta, and trifecta wagering.

In some implementations, the method 800 further includes combining and reformatting the RRD into a standardized data feed that is receivable by parimutuel platforms that provide real-time odds for betting based upon the analyzed data.

In an exemplary example implementation of the techniques of the disclosure, a computer readable medium includes computer executable instructions for implementing the method for enhancing spectator experience during an event. In an example, the computer readable medium that is capable of storing both event data and executable software instructions may include, but not be limited to, a memory card, a CD-ROM or DVD that can be read by a computer's optical drive, a USB Flash Drive, a Hard Disk Drive, a Solid State Drive, Magnetic Tape, Cloud Storage in which files and instructions are stored like Google Drive or Dropbox, network storage, remote repositories, ROM, EPROM, or EEPROM.

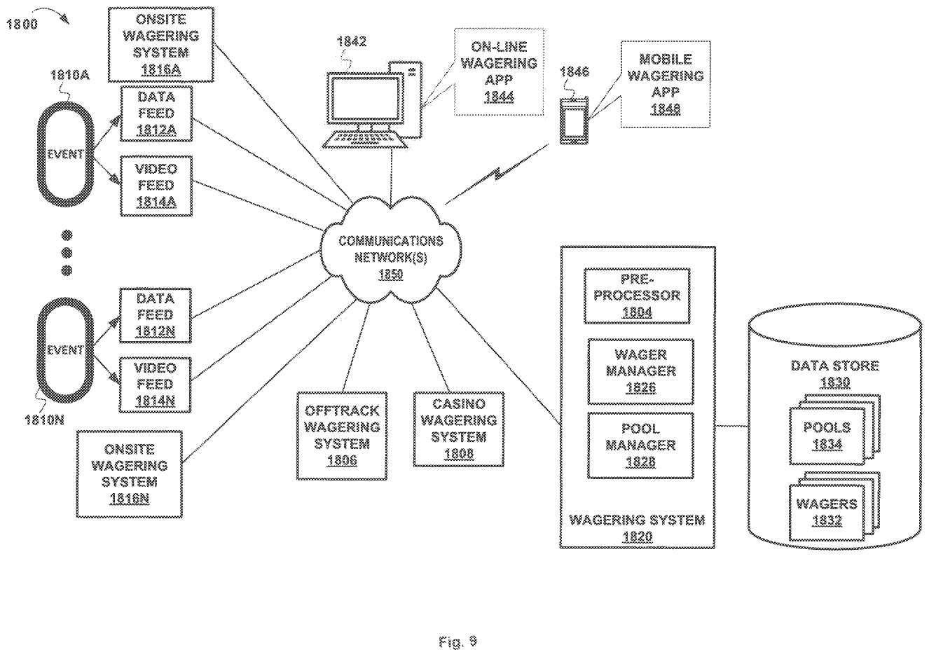

FIGS. 1-8 discussed above provide systems and methods to enhance spectators' experiences at events and for implementing pari-mutuel wagering in human, non-animal race events and scored contests where the field of participants is comprised of individual competitors or individual race teams that comprise more than one participant member on a worldwide basis. FIGS. 9-12 discussed below provide further techniques that may be used in addition to, or instead of, the techniques, systems, and methods described above. The techniques described below with respect to FIGS. 9-12 are directed to multi-stage events such as, for example, multi-stage sports competition events that feature fields of individual race and contest competitors such as motorsports, sailing, track and field, golf, swimming, skiing, and bicycle racing events. An example of a multi-stage motorsport event is a NASCAR Cup Series event. With the exception of longer races such as the Coca Cola 600, each race in the series has three stages. Points are awarded based on finishing position of each stage. In some implementations of multi-stage racing, the race does not stop after a stage. Instead, during the period between stages, a caution period (also referred to as a yellow flag period) occurs. During this caution period, drivers slow down and maintain their position behind the car in from of them. Passing is typically not allowed during the caution period. However, a car may reduce the distance to the car in front during the caution period. This tends to make the cars grouped more closely together when a car may make a pit stop during the caution period and can refuel, change tires, or make other adjustments. However, a car making a pit stop during the caution period loses its position and acquires a new position upon leaving the pit area. At the end of the caution period, the green flag comes out and the race resumes with the next stage. Another example of multi-stage racing events are the bicycle Grand Tours, being the Tour de France, Giro d′Italia, Vuelta a Espana, and the one-week UCI WorldTour races, which are multi-day events composed of consecutive daily races, or stages, with the overall winner decided by the lowest cumulative time across all stages. Golf has the PGA Tour's and the US Open, LIV Golf Promotions to name a few. Sailing has the Atlantic Cup, the America's Cup and the SailGP, all with stages that can have a duration of one day to several weeks or months. And perhaps the most well-known being the Olympics, with staged events that feature fields of individual race and contest competitions in track and field, swimming and skiing.

FIG. 9 is a block diagram illustrating a system 1800 for conducting pari-mutuel wagering on multi-stage events. In some aspects, system 1800 wagering system 1820, data feeds 1812A-1812N, and video feeds 1814A-1814N are communicatively coupled by one or more communication networks 1850. In some aspects, the communications network(s) 1850 may include one or more networks comprising the Internet. In some aspects, the communication network(s) may include private networks.

Data feeds 1812A-1812N provide event data for a respective event 1810A-1810N to preprocessor 1804. As an example, events 1810A-1810N may be multi-stage motorsports events such as multi-stage auto racing events. In this example, a data feed corresponding to a motorsport event may include various statistics and other information regarding an event in the event data. Such statistics and information may include one or more of the start time and end time of the stage, the participants in the stage, and the results of the stage. A data feed corresponding to the event may also include supplemental data such as qualifying times of the participants, lap times, results of past races for participants or teams, performance of participants or teams against other participants or teams, scores of participants or teams of racers, and the like.

Data feeds 1812A-1812N and video feeds 1814A-1814N may be provided, for example, by sanctioning bodies associated with events 1810A-1810N. Different sanctioning bodies may provide different data elements in their respective data feeds 1812A-1812N, and the data may be in different formats. Examples of such sanctioning bodies include the North American Stock Car Racing Association (NASCAR), the Automobile Racing Club of America (ARCA), IndyCar, Fédération Internationale de l′Automobile (FIA), among others. A data feed for an event may be provided by a first entity, and the video feed for the same event may be provided by a different second entity. In some aspects, a licensed data provider may provide a data feed and/or video feed in addition to, or instead of, a sanctioning body. As an example, Al Kamel Systems of Barcelona Spain is a licensed provider of motorsports racing data. Video feeds 1814A-1814N provide video information for a respective event 1810A-1810N to preprocessor 1804. As an example, a video feed corresponding to a multi-stage event may be video data of some or all of a stage of the event. In the example above of a motorsports event, the video data may include the entire race (e.g., the entire stage of each stage of the race) or may include portions of a race or stage (e.g., the beginning of the race or stage, the finish of the race or stage, or significant occurrences during the race or stage).

Wagering system 1820 manages wagering activities that may be associated with various types of wagering entities. Such wagering entities can include onsite wagering 1816, offtrack wagering site 1806, casino 1808, online wagering application 1844, or mobile wagering application 1848, among others. Onsite wagering 1816 includes wagering devices located at the site of an event (e.g., one of events 1810A-1810N). In some implementations, wagering system 1820 includes preprocessor 1804, wager manager 1826, and pool manager 1828.

Preprocessor 1804 receives the event data and supplemental data (if any) from data feeds 1812A-1812N and video information from video feeds 1814A-1814N. As noted above, the data provided by data feeds 1812A-1812N may include different data elements, may be in different formats, and may be differently organized from the data that can be accepted by wagering system 1820 and from one another. In some aspects, preprocessor 1804 performs data transformations to the incoming data to generate data in a format that can be accepted and correctly processed by wagering system 1820. For example, the preprocessor 1804 can transform the incoming data feeds 1812A-1812N to a standardized data format that can be accepted by a wagering system such as wagering system 1820. Such transformations may include translating or mapping values, rearranging the order of data fields, adding or deleting data fields, padding or truncating data, among others. Although shown as part of wagering system 1820, the functionality provided by preprocessor 1804 may be separate from wagering system 1820 and further may be distributed across multiple entities.

Offtrack wagering site 1806 can be a site where wagering activities can be performed that are remote from the site of the event. Special purpose devices for conducting wagering activities may be used at the offtrack wagering site 1806. Although referred to as an “offtrack” wagering site, the event need not necessarily be a track based event, but can include other multi-stage events. The offtrack wagering site 1806 can include devices for presenting information regarding racing events (e.g., multi-stage racing events) and accepting pari-mutuel wagers (also referred to as “bets”) on the racing events.

Casino 1808 can be a conventional casino that provides a variety of different wagering games and game formats. Like the offtrack wagering site 1806, the casino 1808 can include devices for presenting information regarding racing events (e.g., multi-stage racing events) and accepting pari-mutuel wagers on the racing events.

Online wagering application 1844 is an application configured for use on a computing device 1842. Computing device 1842 may be a personal computer, desktop computer, laptop computer, set-top box, an Internet-of-Things (IoT) device, smart appliances, and the like. Like the devices at the offtrack wagering site 1806 and the casino 1808, the online wagering application 1844 may present information regarding racing events and accept pari-mutuel wagers on the racing events.

Mobile wagering application 1848 can be an application configured for use on a mobile device 1846. Mobile device 1846 may be a smartphone, tablet computer, navigation device, vehicle-based communication system, and the like. Like online wagering application 244, mobile wagering application 1848 can present information regarding racing events and accept pari-mutuel wagers on the racing events.

The operation of system 1800 will now be described with respect to a single event 1810A. The operation with respect to event 1810A applies as well to the other events 1810B-1810N. The events 1810A-1810N may take place at separate times from one another, or an event may take place concurrently with one or more other events. Pre-processor 1804 and wagering system 1820 may thus be processing input and providing output for multiple events.

Pre-processor 1804 may receive data from data feed 1812A via communication network 1850 prior to the beginning of the event 1812A and may continue to receive data via data feed 1812A throughout the event 1810A. For example, prior to the beginning of a multi-stage event, pre-processor 1804 may receive data including the identities of the participants in the event (e.g., individual racers, cars, teams, etc.) that will be participating in the event. Data feed 1812A may also provide supplemental data such as qualifying times for the participants. During the multi-stage event, data feed 1812A may provide data regarding a stage of the multi-stage event. For example, the data may include an indication that the stage has started. Further, the data may include the current positions of the participants or the final position of the participants that finished the stage. Similarly, the data may include data for subsequent stages of the event, including an indication that the stage has started, current positions of participants during the stage, and/or the final positions of the participants upon completion of the stage. The data provided by data feed 1812A may also include some or all of the ERD described above.

Pre-processor 1804 receives the data from data feed 1812A, and as noted above, transforms the data into a format that can be processed by wagering system 1800. In some examples, the data from data feed 1812A may already be in a format that can be processed by wagering system 1820. In some aspects, pre-processor 1804 may pass the data through to wagering system 1820. In some other aspects, wagering system 1820 may receive the data directly from data feed 1812A, bypassing pre-processor 1804.

Wagering system 1820 receives data from data feed 1812A, either indirectly through pre-processor 1804 or directly from data feed 1812A. In some aspects, wagering system 1820 (or pre-processor 1804) may include a communication subsystem for obtaining data from the data feed 1812. As an example, the communication subsystem may be an implementation of communication subsystems 102, 502, 902, or 1402 of FIG. 1, 5, 9, or 14, respectively.

Wagering system 1820 can provide some or all of the data (after any pre-processing if necessary) to one or more of on-line wagering application 1844, mobile wagering application 1848, onsite wagering system 1816, offtrack wagering site 1806, or casino 1808 (generically referred to as a “wager placement entity”) The wagering placement entity can display the data to a wagerer (also referred to as a “user” or “bettor”) and receive a wager type and a wager amount from the wagerer. As an example, a wager type may be “win,” “place,” “show,” “quinella,” “exacta,” “trifecta,” or “superfecta” for each stage of the event or a pick three, pick four, etc. for multi-stage events. A description of various wager types that may be supported by the techniques of the disclosure is provided below.

Wagering system 1820 uses the wager types and wager amounts to determine betting odds to present to a wagerer of a wager placement entity. In some aspects, wagering system 1820 uses parimutuel betting techniques to determine odds and payouts. The term “pari-mutuel” is based on a French expression meaning “a wager among ourselves.” In pari-mutuel wagering, the winners share a portion of a purse that includes the amounts wagered on an event. Another portion of the purse includes a commission for the wagering system operator. In accordance with the techniques described elsewhere in this disclosure, another portion of the purse includes payouts to participants of the event, where the payout to a participant may be based, at least in part, on the results achieved by the participant in a stage or stages of the multi-stage event. In effect, wagered amounts of the losers are distributed among the winners, the wagering system operator, and the participants of the multi-stage event.

Wagering system 1820 can support various wager types. In some aspects, wagering system 1820 can support various combinations of one or more of the following wager types for a stage of a multi-stage event:
Win—The wagerer's selected participant finishes first of the stage.
Place—The wagerer's selected participant finishes first or second of the stage.
Show—The wagerer's selected participant finishes first, second, or third of the stage.
Exacta—The wagerer correctly selects the first and second place finishers of the stage in exact order.
Quinella—The wagerer correctly selects the first and second place finishers of the stage in any order.
Trifecta—The wagerer correctly selects the first, second, and third place finishers of the stage in exact order.
Superfecta—The wagerer correctly selects the first, second, third, and fourth place finishers of the stage in exact order.

In some implementations, the wagering system 1820 may support a wager based on the results of two or more stages of a multi-stage race. As an example, a wagerer may place a single wager on the results of each stage of a multi-stage event. For instance, a wagerer may place a wager that selects the first-place finisher for each stage, or combination of stages, for the multi-stage event. As an example, a “Pick 3” option may be provided in which the wagerer wagers on the results of three stages of the multi-stage event. In some implementations, the three stages are consecutive stages of the multi-stage event. Other combinations may be offered that include fewer stages or more stages. The wager may specify the same participant as the first-place finisher in each stage of the combination or may specify different participants as the first-place finisher for each stage of the combination. The wagerer may specify various combinations of stages, finishing positions, and participants when placing a wager.

In some aspects, wagering system 1820 stops accepting wagers for a stage after the stage has begun. In some aspects, wagering system 1820 stops accepting wagers for a combination of stages after the beginning of the earliest stage of the combination. In some aspects, the wagering system 1820 stops accepting wagers for every stage of the multi-stage event after the beginning of the first stage of the multi-stage event.

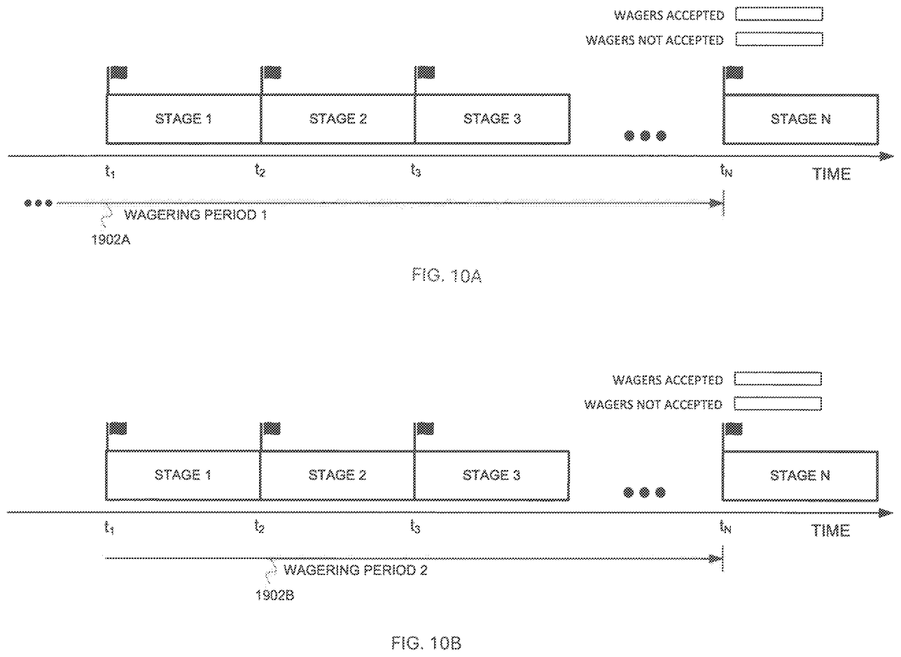

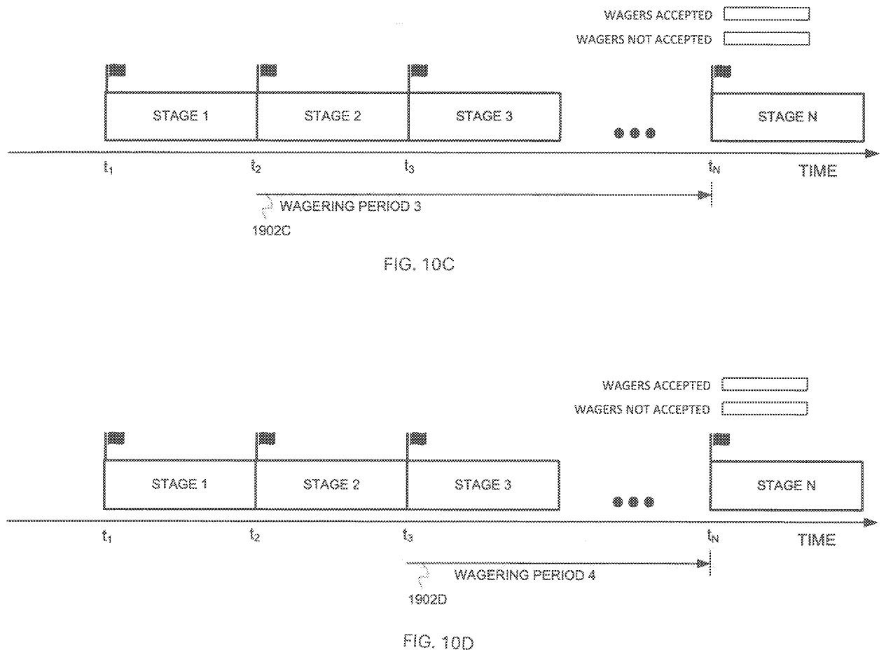

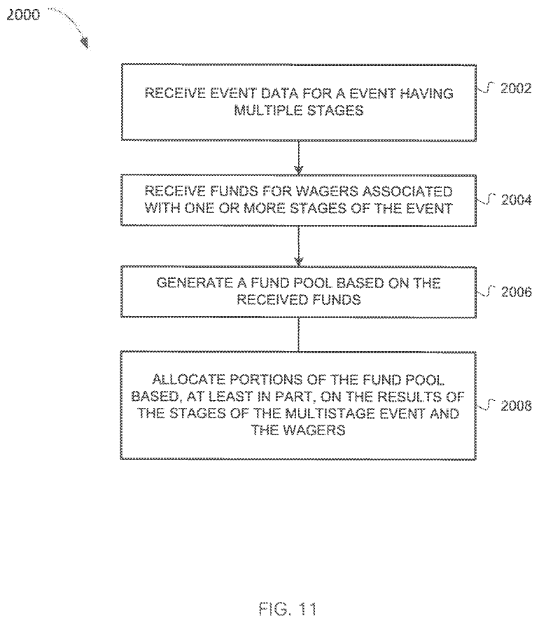

FIGS. 10A-10D illustrate wagering periods during an example multi-stage event having N stages, such as a multi-stage motorsports event. N may be a positive integer greater than 1. In some aspects, N may be three (3). In some other aspects, N may be four (4). The techniques of the disclosure are not limited to any particular value of N.

The stages 1-N of FIGS. 10A-10D are shown with the end of one stage immediately followed by the beginning of the next stage. For example, as noted above, in a motorsport race event there may be a caution period between the end of one stage and the beginning of the next stage that is not shown in FIGS. 19A-19D. The shaded stages in FIGS. 10A-10D indicate stages for which wagers are accepted during a wagering period. Unshaded stages indicate stages for which wagers are not accepted.

FIG. 10A is a conceptual diagram illustrating an example first wagering period for a multi-stage event. In the example of FIG. 10A, a first wagering period 1902A begins prior to the start of the first stage (e.g., stage 1) of the multi-stage event at time t₁ and continues until the beginning of the final stage N at time ty. During the first wagering period 1902A, a wagerer may place one or more wagers on the results of one or more of any of the stages 1-N. As noted above, the wagers may be for individual stages or they may be for combinations of two or more stages. Using the Pick 3 wagering type as an example of a combination wager, during betting period 1902A, a wagerer may place a wager of any three consecutive stages. In this case, the wagerer may specify a Pick 3 wager on the results of stages 1 to 3, 2 to 4, . . . or N−2 to N.

FIG. 10B is a conceptual diagram illustrating an example of a second wagering period for the multi-stage event. The example of FIG. 10B continues the example described above with respect to FIG. 10A and describes a second betting period 1902B that begins after stage 1 has begun (e.g., after time t₁) and runs until the beginning of the final stage N at time ty. During the second betting period 1902B, wagering system 1820 does not accept any wagers involving the results of stage 1. Wagering system 1820 accepts wagers on the results of one or more of stages 2-N. As noted above, the wagers may be placed for the results of a single stage or for combinations of stages. Using the example of a Pick 3 wager type, during betting period 1902B, if the race is a three stage race (e.g., N=3), the Pick 3 wager type would not be available to the wagerer because wagering will only be accepted for stages 2 and 3. If the race has four or more stages (e.g., N>3), the Pick 3 type would be available with respect to stages 2 through N.

FIG. 10C is a conceptual diagram illustrating an example of a third wagering period for the multi-stage event. The example of FIG. 10C continues the examples described above with respect to FIGS. 10A and 10B and describes a third betting period 1902C that begins after stage 2 has begun (e.g., after time t₂) and runs until the beginning of the final stage N at time ty. During the third betting period 1902C, wagering system 1820 does not accept any wagers involving the results of stage 1 and stage 2. Wagering system 1820 accepts wagers on the results of one or more of stages 3-N. As noted above, the wagers may be placed for the results of a single stage or for combinations of stages (if there are enough stages remaining in the multi-stage event). Using the example of a Pick 3 wager type, during betting period 1902C, if the race is a three-stage race (e.g., N=3), the Pick 3 wager type would not be available to the wagerer because wagering will only be accepted for stage 3. If the race has five or more stages (e.g., N>4), the Pick 3 type would be available with respect to stages 3 through N.

FIG. 10D is a conceptual diagram illustrating an example fourth wagering period for the multi-stage event. The example of FIG. 10D continues the examples described above with respect to FIGS. 10A, 10B and 10C, and describes a fourth betting period 1902D that begins after stage 3 has begun (e.g., after time t₃) and runs until the beginning of the final stage N at time tv. During the fourth betting period 1902D, wagering system 1820 does not accept any wagers involving the results of stages 1, 2, and 3. Wagering system 1820 accepts wagers on the results of one or more of stages 4-N (if the event has more than three stages, e.g., N>3). As noted above, the wagers may be placed for the results of a single stage or for combinations of stages (if there are enough stages remaining in the multi-stage event).

FIGS. 10A-10D have describes implementations where wagers for a multi-stage event are accepted for any stage of the event that has not yet begun. In other implementations, wagering for every stage of the event are accepted up until the beginning of the first stage of the event.

Returning to FIG. 1, the wagering system 1820 accepts wagers for stages and combinations of stages (if supported) for those stages that have not yet begun. Wagering system 1820 can include a pool manager 1828 that maintains data in data store 1830 for the wagering activity. For example, pool manager 1820 can maintain a pool 1834 for each event 1810 that pools the wagered amount for the event. The pool may be referred to as the handle for the event. Similarly, wagering system 1820 can include a wager manager 1826 that records the wagers 1832 associated with each event. For example, wagers 1832 for an event may include the wager type, odds, and wager amount for each wager placed for a stage of an event.

Data store 1830 can be any type of data storage system, including distributed data storage systems, cloud-based data storage systems, or dedicated hardware-based storage systems. In some aspects, data store 1830 may be an implementation of databases 110 and 510 of FIGS. 1 and 5, 9, respectively.

Wagering system 1820 uses data in data store 1830 (e.g., the wagers 1832, among other data) to determine current wagering odds for the various types of wagers supported for an event. For example, wagering system 1820 can use pari-mutuel analysis techniques to generate the current wagering odds for the event based on the wagers 1832. The wagering system 1820 can transmit the current wagering odds to the various wagering placement entities that are participating in the wagering activity for use in displaying wagering information and accepting wagers.

Wagering system 1820 determines a distribution of the handle for the event (e.g., the pool of wagered funds for the event) when the results of the event are made official. The majority of the handle is distributed back to the wagerers as winnings, in accordance with their corresponding wager amounts, wager types, odds, and results of the stages of the multi-stage event.

A portion of the handle may be allocated to the operator of the wagering game system 1820 (e.g., as a transaction commission). In another embodiment of the present invention, a portion of the handle may be allocated to a jurisdictional regulatory gaming agency. In another embodiment of the present invention, a portion of the handle may be allocated to the owner of the track or event facility where the event is conducted. In another embodiment of the present invention, a portion of the handle may be allocated to a sanctioning body for the race event. In another embodiment of the present invention, a portion of the handle may be allocated to the owner(s) of one or more teams that participate in the race event.

In another embodiment of the present invention, a portion of the handle may be allocated to the purse for the event that is paid out to one or more participants of the race event.

As noted above, a portion of the handle is allocated to the purse. In addition to the portion of the handle that is allocated to the purse, the purse may also include funds that are provided by the sponsors and/or entry fees. When the results of the race are determined, the purse may be distributed to the participants. For example, in one embodiment of the present invention, the payout of the purse for a field with more than ten participants may be as follows:
51% to the winner, (e.g., “more than half”),
20% to second,
12% to third,
8% to fourth,
5% for fifth,
Remaining 4% split equally among remaining participants.

In another embodiment of the present invention, in a field having less than ten participants, the distributions above may be changed by adding 1% additional payout to positions 1-5, thereby changing the split to 52% for first, 21% for second, 13% for third, 9% to fourth, 6% to fifth and then the balance divided equally among the remaining participants.

The distributions shown above can pay the entire field of finishers, which has an advantage over conventional systems in that it encourages participation in the sport and larger fields, which is good for the sport. The distributions shown above are for particular implementations of the techniques of the disclosure, and other implementations may use different distributions that are within the scope of the inventive subject matter. For example, in a large field, the amount shared by the participants finishing after fifth place may share in a larger percentage by reducing the percentages of one of more of first to fifth place.

The importance of pari-mutuel waging as a funding mechanism for sports should not be underrated. Participation in the vast majority of sports beyond youth sports is not inexpensive. Pari-mutual wagering creates the purse, and the distribution of the purses funds the sport at every level. Most sports at the grass-roots level are self-funded and play important roles in the physiological and psychological development of participants. Sports are also an important economic driver for the economy. Aside from sponsorships, which are generally not available to the athletes and participants until a certain level of achievement, inadequate funding keeps many would be participants on the side lines. The purses derived from the pari-mutuel wagering can provide a new funding mechanism and provide opportunity for growth within the sport. It is good for the economy and the personal development of the athletes and respective teams.

In addition to receiving data via data feed 1812A, as noted above, the wagering system 1820 may receive video data from video feed 1814A associated with the event 1810A. The wagering system 1820 may provide some or all of the video data for an event to one or more of the wagering entities.

FIG. 11 is a flow chart diagram 2000 illustrating an example method for conducting pari-mutuel wagering on multi-stage events. The operations may be performed, for example, by wagering system 1820 of FIG. 9.

At block 2002, the wagering system receives event data for an event having multiple stages. The data may include various statistics and other information regarding the event. Such statistics and information may include one or more of the start time and end time of a stage, the participants in the stage, and the results of the stage. A data stream may also include supplemental data such as qualifying times of the participants, lap times, results of past races for participants or teams, performance of participants or teams against other participants or teams, scores of participants or teams of racers, and the like.

At block 2004, the wagering system receives wagers and funds for wagers associated with one or more stages of the multi-stage event. As noted above, the wagers may specify a wager type and a wager amount. The wagering system may record the wagers in a data store (e.g., data store 1830).

At block 2006, the wagering system generates a fund pool based on the received funds.

At block 2008, the wagering system allocates portions of the fund pool. In some aspects, the wagering system allocates at least one portion of the fund pool based, at least in part, on the results of the stages of the multi-stage event. In some aspects, the wagering system may allocate at least one portion of the fund based on the results of the stages of the multi-stage event and the wagers associated with the stages. In some aspects, the wagering system may allocate a portion of the fund pool as a commission for the operator of the wagering system.

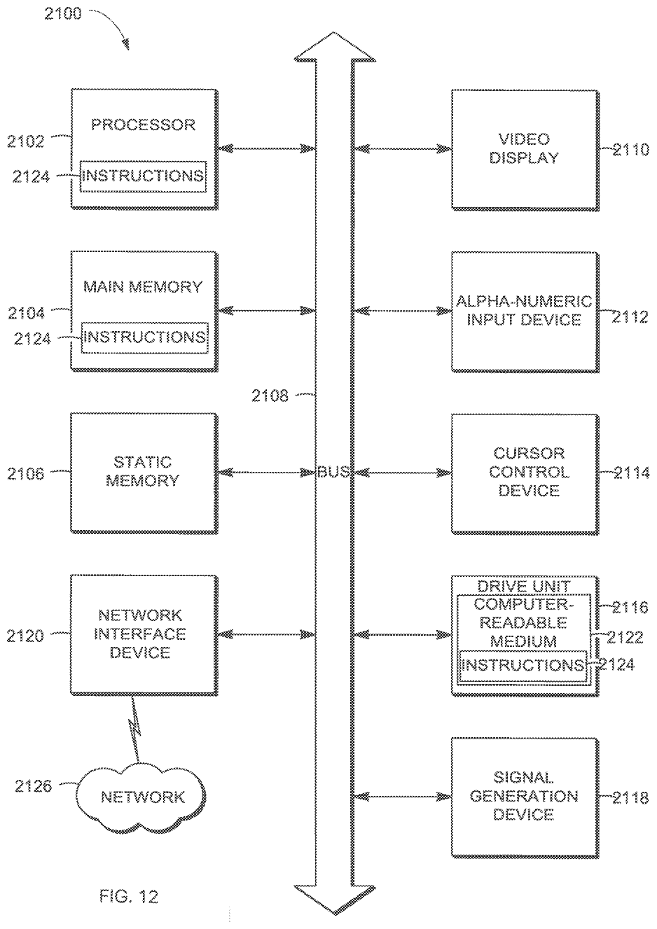

FIG. 12 is a block diagram of an example computer system upon which embodiments of the inventive subject matter can execute. The description of FIG. 21 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular data types.

As indicated above, the system as disclosed herein can be spread across many physical hosts. Therefore, many systems and sub-systems of FIG. 12 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, smart phones, network PCs, minicomputers, mainframe computers, and the like. Embodiments of the invention may also be practiced in distributed computer environments where tasks are performed by I/O remote processing devices that are linked through a communications network. In a distributed computing environment, program modules may be located in both local and remote memory storage devices.

With reference to FIG. 12, an example embodiment extends to a machine in the example form of a computer system 2100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 2100 may include a processor 2102 (e.g., a central processing unit (CPU), a graphics processing unit (GPU) or both), a main memory 2104 and a static memory 2106, which communicate with each other via a bus 2108. The computer system 2100 may further include a video display unit 2110 (e.g., a liquid crystal display (LCD) or a cathode ray tube (CRT)). In example embodiments, the computer system 2100 also includes one or more of an alpha-numeric input device 2112 (e.g., a keyboard), a user interface (UI) navigation device or cursor control device 2114 (e.g., a mouse), a disk drive unit 2116, a signal generation device 2118 (e.g., a speaker), and a network interface device 2120.

The disk drive unit 2116 includes a machine-readable medium 2122 on which is stored one or more sets of instructions 2124 and data structures (e.g., software instructions) embodying or used by any one or more of the methodologies or functions described herein. The instructions 2124 may also reside, completely or at least partially, within the main memory 2104 or within the processor 2102 during execution thereof by the computer system 2100, the main memory 2104 and the processor 2102 also constituting machine-readable media.

While the machine-readable medium 2122 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; CD-ROM and DVD-ROM disks and present or future cloud and space based storage or processing systems.

The instructions 2124 may further be transmitted or received over a communications network 2126 using a signal transmission medium via the network interface device 2120 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

The discussion of FIGS. 9-12 above has been presented in the context of motorsports events having multiple stages. However, the disclosure is not limited to motorsports events. For example, the techniques of the disclosure may be readily applied to other non-animal related events having multiple stages such as bicycle races (e.g., the Tour de France), multi-sport events (e.g., triathlon, pentathlon, decathlon, and the like), golf tournaments (comprising three or four rounds), sailing races, and other multi-stage sporting events.

In yet another embodiment of the present invention, a method for parimutuel wagering for non-animal sports and race events having a plurality of stages (with the entirety of the race event comprising a single stage), the method comprising: receiving race data for the motorsports race event prior to and during the event, wherein the race data comprises results from the plurality of stages; receiving funds for a plurality of wagers associated with a selected stage of the plurality of stages; generating a fund pool based on the funds received for the selected stage; and allocating portions of the fund pool based, at least in part, on the received race data for the selected stage. Portions of the fund pool may also be allocated, at least in part, on the wagered amounts for the selected stage. Portions of the fund pool may also be allocated, at least in part, on the odds associated with the wagers for the selected stage. Portions of the fund pool may also be allocated, at least in part, on the wager type for the selected stage. The wager type may comprise one or more of win, place, show, exacta, quinella, trifecta, or superfecta. The wager type may also comprise a combination of win, place, show, exacta, quinella, trifecta, or superfecta for at least two of the plurality of stages. The wager type may also comprise a pick 3 type wager specifying the win, place, or show for at least three of the plurality of stages. A first portion of the fund pool may be allocated to one or more persons that placed a wager for the selected stage. A second portion of the fund pool may be allocated to an operator of a parimutuel wagering service. A third portion of the fund pool maybe allocated to a jurisdictional regulatory gaming agency. A fourth portion of the fund pool may be allocated to the track owner for the race event. A fifth portion of the fund pool may be allocated to a sanctioning body for the race event. A sixth portion of the fund pool may be allocated to one or more team owners for the race event. A seventh portion of the fund pool may be allocated to one or more participants in the race event. A wager for the selected stage is accepted if received prior to the beginning of the selected stage, and is refused if received after the beginning of the selected stage. Further, a wager associated with two or more of the plurality of stages is accepted if received prior to the earliest of the selected stages, and is refused if received after the beginning of the earliest of the selected stages.

While there has been shown, and described herein what are presently considered the preferred embodiments of the present disclosure, it will be apparent to those skilled in the art that various changes and modifications can be made therein without departing from the scope of the present disclosure as defined by the appended claims.

While certain embodiments have been described, these embodiments have been presented by way of example only and are not intended to limit the scope of the present disclosure. Indeed, the novel devices and systems described herein may be embodied in a variety of other forms. Furthermore, various omissions, substitutions, and changes in the form of the devices, and systems described herein may be made without departing from the spirit of the present disclosure. The accompanying claims and their equivalents are intended to cover such forms or modifications as would fall within the scope and spirit of the present disclosure.

Moreover, although the techniques of the disclosure and their advantages have been described in detail, it should be understood that various changes, substitutions, and alterations can be made herein without departing from the inventive subject matter as defined by the appended claims. Moreover, the scope of the present application is not intended to be limited to the particular embodiments of the machine, manufacture, composition of matter, and means, described in the specification. As one will readily appreciate from the disclosure, processes, machines, manufacture, compositions of matter, means, presently existing or later to be developed that perform substantially the same function or achieve substantially the same result as the corresponding embodiments described herein may be utilized. Accordingly, the appended claims are intended to include within their scope such processes, machines, manufacture, compositions of matter, means.

1. A method for parimutuel wagering for non-animal sports and race events having a plurality of stages, the method comprising:
receiving race data for the motorsports race event prior to and during the event, wherein the race data comprises results from the plurality of stages;
receiving funds for a plurality of wagers associated with a selected stage of the plurality of stages;
generating a fund pool based on the funds received for the selected stage;
allocating portions of the fund pool based, at least in part, on the received race data for the selected stage.

2. The method of claim 1, wherein one of the plurality of stages is the entirety of the race event.

3. The method of claim 1, wherein the allocating step is based, at least in part, on the wager amount for the selected stage.

4. The method of claim 1, wherein the allocating step is based, at least in part, on the odds associated with the wager for the selected stage.

5. The method of claim 1, wherein the allocating step is based, at least in part, on the wager type for the selected stage.

6. The method of claim 5, wherein the wager type comprises one or more of win, place, show, exacta, quinella, trifecta, or superfecta.

7. The method of claim 5, wherein the wager type comprises a combination of win, place, show, exacta, quinella, trifecta, or superfecta for at least two of the plurality of stages.

8. The method of claim 5, wherein the wager type comprises a pick 3 type wager specifying the win, place, or show for at least three of the plurality of stages.

9. The method of claim 1, wherein the allocating step comprises allocating a first portion of the fund pool to one or more persons that placed a wager for the selected stage.

10. The method of claim 1, wherein the allocating step comprises allocating a second portion of the fund pool to an operator of a parimutuel wagering service.

11. The method of claim 1, wherein the allocating step comprises allocating a third portion of the fund pool to a jurisdictional regulatory gaming agency.

12. The method of claim 1, wherein the allocating step comprises allocating a fourth portion of the fund pool to the track owner for the race event.

13. The method of claim 1, wherein the allocating step comprises allocating a fifth portion of the fund pool to a sanctioning body for the race event.

14. The method of claim 1, wherein the allocating step comprises allocating a sixth portion of the fund pool to one or more team owners for the race event.

15. The method of claim 1, wherein the allocating step comprises allocating a seventh portion of the fund pool to one or more participants in the race event.

16. The method of claim 1, wherein a wager for the selected stage is accepted if received prior to the beginning of the selected stage, and is refused if received after the beginning of the selected stage.

17. The method of claims 7 and 8, wherein a wager associated with two or more of the plurality of stages is accepted if received prior to the earliest of the selected stages, and is refused if received after the beginning of the earliest of the selected stages.
